(19) United States
(12) Patent Application Publication
(10) Pub. No.: US 2002/0188960 A1
(43) Pub. Date: Dec. 12, 2002

(54) Multiple information levels in media services menus

(76) Inventors: Arturo A. Rodriguez, Norcross, GA (US); John Eric West, Roswell, GA (US)

Correspondence Address: Scientific-Atlanta, Inc., Intellectual Property Dept. MS 4.3.518, 5030 Sugarloaf Parkway, Lawrenceville, GA, 30044, US

(21) Appl. No.: 09/879,292

(22) Filed: Jun. 12, 2001

(51) Int. Cl. H04N 7/173

(52) U.S. Cl. 725/120; 725/87; 725/91; 725/93; 725/117

(57) ABSTRACT

A user is provided with a media services menu in response to user input. The media services menu may be displayed on a display device such as a television. User input may be provided via a remote control device. Information contained in or provided in connection with the media services menu is responsive to a user experience level, to one or more user determined settings, and/or to a lack of user input.

### FIELD OF THE INVENTION

This invention relates in general to television systems, and more particularly, to the field of interactive television interfaces.

### BACKGROUND OF THE INVENTION

Cable television systems are now capable of providing many services in addition analog broadcast video. In implementing enhanced programming, the home communication terminal (“HCT”), otherwise known as the settop box, has become an important computing device for accessing various video services. In addition to supporting traditional analog broadcast video functionality, digital HCTs (or “DHCTs”) now also support an increasing number of two-way digital services such as video-on-demand.

A DHCT is typically connected to a cable or satellite television network and includes hardware and software necessary to provide various services and functionality. Preferably, some of the software executed by a DHCT is downloaded and/or updated via the cable television network. Each DHCT also typically includes a processor, communication components and memory, and is connected to a television or other display device, such as a personal computer. While many conventional DHCTs are stand-alone devices that are externally connected to a television, a DHCT and/or its functionality may be integrated into a television or personal computer, as will be appreciated by those of ordinary skill in the art.

A DHCT can provide users with various services including, for example, an interactive program guide and video-on-demand (VOD). A user may typically request a DHCT service via a menu that is displayed on a television screen. Such a menu may be displayed along with related menu information. Such menu information may include instructions and/or suggestions that can help the user in using the menu or in making a selection. For some users the menu information may not provide enough assistance, whereas for others it may consist of extraneous information. One problem with providing too little menu information is that some inexperienced users may be intimidated by the perceived complexity or ambiguity of the menu and may decide not to use the services provided by such menu; other inexperienced users may end up spending too much time trying to determine how to navigate through various menu options. On the other hand, providing too much menu information may take up unnecessary screen area that could otherwise be used to display data that the user may be more interested in viewing. Therefore, there exists a need for a system and method for providing a more appropriate level of menu information.

### SUMMARY OF THE INVENTION

In one embodiment of the invention, information provided in connection with a media services menu is variable. In another embodiment of the invention, the information is responsive to a user determined setting. In yet another embodiment, the information is responsive to a lack of user input.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following drawings. The components in the drawings are not necessarily drawn to scale, emphasis instead being placed upon clearly illustrating the principles of the present invention. In the drawings, like reference numerals designate corresponding parts throughout the several views.

FIG. 1 is a block diagram of an example cable television system in accordance with one preferred embodiment of the present invention.

FIG. 2 is a block diagram of a DHCT and related equipment, in accordance with one preferred embodiment of the present invention depicted in FIG. 1.

FIG. 3 is a remote control device that can be used to provide user input to the DHCT shown in FIG. 2.

FIG. 4A depicts an example quick settings window that may be provided in response to the activation of the “settings” button on the remote control device of FIG. 3.

FIG. 4B depicts an example quick settings window that may be provided in response to the activation of the “help settings” button on the remote control device of FIG. 3.

FIG. 5A is a diagram depicting an example video-on-demand catalog window containing a high level of menu help.

FIG. 5B is a diagram depicting an example video-on-demand catalog window containing a medium level of menu help.

FIG. 5C is a diagram depicting an example video-on-demand catalog window containing a low level of menu help.

FIG. 6 is a diagram depicting an example rental period selection window containing a high level of menu help.

FIG. 7 is a display diagram of a browse-by window containing a high level of menu help.

FIG. 8 is a diagram depicting an example video-on-demand settings window containing a high level of menu help.

FIG. 9 is a diagram depicting an example video-on-demand block categories window containing a high level of menu help.

FIGS. 10 depicts and example screen layout that is configured to provide a medium level of menu help.

FIGS. 11 depicts and example screen layout that is configured to provide a low level of menu help.

FIG. 12A depicts an example interactive program guide window 1200A that contains a high level of menu help.

FIG. 12B depicts an example interactive program guide window that is configured to provide a medium level of menu help.

FIG. 12C depict an example interactive program guide window that is configured to provide a low level of menu help.

FIG. 13 depicts one possible sequence of help banners that may be presented to a user who does not provide input within a predetermined amount of time after the initial presentation of an interactive program guide.

### DETAILED DESCRIPTION OF THE PREFERRED EMBODIMENTS

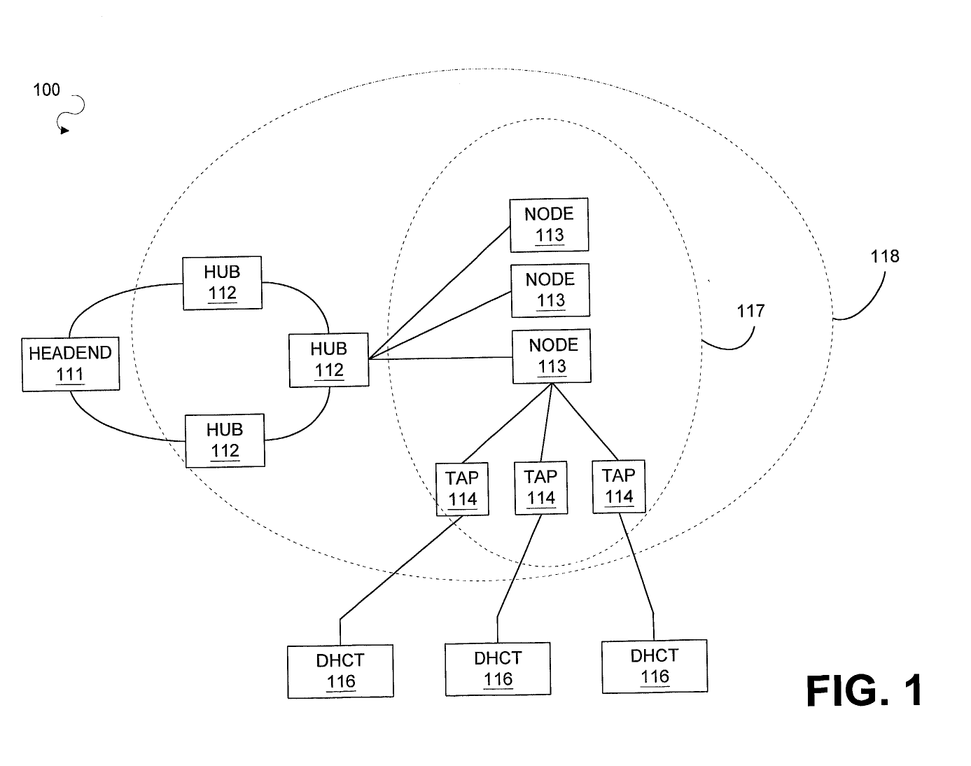

The present invention may, in one embodiment, be implemented as part of a subscriber television system (STS). Hence, an illustrative STS 100 and its operation will be described initially. FIG. 1 shows a block diagram view of a non-limiting example of an STS 100, which is generally a high quality, reliable and integrated network system that features video, audio, voice and data services to DHCT users. Although FIG. 1 depicts a high level view of an STS 100, it should be appreciated that a plurality of cable television systems can tie together a plurality of regional networks into an integrated global network so that DHCT users can receive content provided from anywhere in the world.

The STS 100 delivers broadcast video signals as digitally formatted signals in addition to delivering traditional broadcast analog video signals. Furthermore, the system can support one way broadcast services as well as both one-way data services and two-way media and data services. The two-way operation of the network allows for user interactivity with services, such as Pay-Per-View programming, Near Video-On-Demand (NVOD) programming according to any of several known NVOD implementation methods, View-on-Demand (VOD) programming (according to any of several known VOD implementation methods), and interactive applications, such as Internet connections and interactive program guide (IPG) applications.

The STS 100 also provides the interfaces, network control, transport control, session control, and servers to access content and services, and distributes content and services to DHCT users. As shown in FIG. 1, a typical STS 100 comprises a headend 111, hubs 112, an HFC access network 117, and users' digital home communication terminals (DHCTs) 116. It should be appreciated that although a single component (e.g. a headend) is illustrated in FIG. 1, an STS 100 can feature a plurality of any one of the illustrated components or may be configured with alternative embodiments for any one of the individual components or with yet other additional components not enumerated above. A content provider (not shown) transmits media content to a headend for further transmission to users downstream in the network.

Content provided by a content provider is communicated by the content provider to one or more headends 111. From those headends the content is then communicated over a communications network 118 that includes a plurality of HFC access networks 117 (only one HFC access network 117 is illustrated). The HFC access network 117 typically comprises a plurality of HFC nodes 113, each of which may serve a local geographical area. The hub 112 connects to the HFC node 113 through a fiber portion of the HFC access network 117. The HFC node 113 is connected to a DHCT 116. Coaxial cables are typically used to couple nodes 113 and taps 114 because the electrical signals can be easily repeated with radio frequency (RF) amplifiers.

As the high-level operations of many of the functions of STSs 100 are well known to those of skill in the art, no further description of the overall STS 100 of FIG. 1 will be included herein. It will be appreciated, however, that the STS 100 shown in FIG. 1 is merely illustrative and should not be construed as implying any limitations upon the scope of the present invention. For instance, subscriber television systems also included within the scope of the invention include systems not utilizing physical structured cabling for transmission, such as, for example, satellite systems. Furthermore, transmission media included within the scope of the invention include, but are not limited to, HFC, optical, satellite, RF, FM, and microwave transmission media. In addition, data provided from the headend 111 to the DHCTs 116 and programming necessary to perform the functions discussed below will be understood to be present in the STS 100, in accordance with the description below.

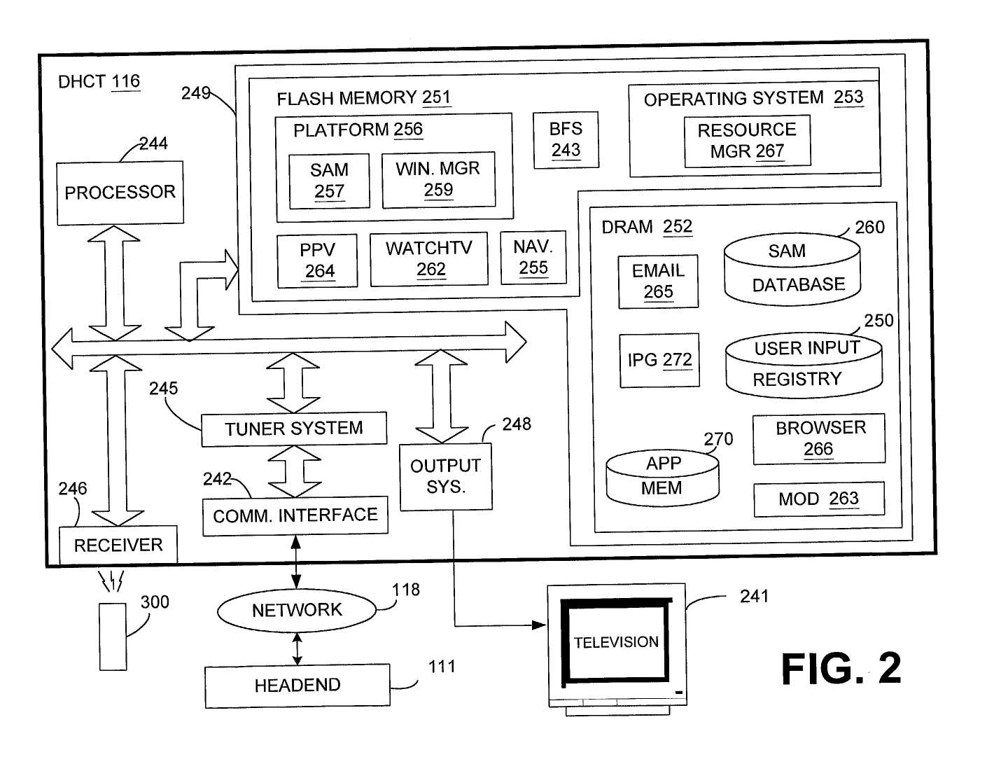

FIG. 2 is a block diagram illustrating a non-limiting example of a DHCT 116 that is coupled to a headend 111 and to a television 241. It should be noted that the DHCT 116 shown in FIG. 2 is merely illustrative and should not be construed as implying any limitations upon the scope of the present invention. Some of the functionality performed by applications executed in the DHCT 116 (such as the MOD client application 263) may instead be performed at the headend 111 and vice versa. A DHCT 116 is typically situated at a user's residence or place of business and may be a stand alone unit or integrated into another device such as, for example, a television set or a personal computer. The DHCT 116 preferably includes a communications interface 242 for receiving signals (video, audio and/or other data) from the headend 111 through the network 118 and for providing any reverse information to the headend 111 through the network 118. The DHCT 116 further includes at least one processor 244 for controlling operations of the DHCT 116, an output system 248 for driving the television display 241, and a tuner system 245 for tuning into a particular television channel to be displayed and for sending and receiving various types of data or media from the headend 111. The tuner system 245 includes, in one implementation, an out-of-band tuner for bi-directional quadrature phase shift keying (QPSK) data communication and a quadrature amplitude modulation (QAM) tuner for receiving television signals. Additionally, a receiver 246 receives externally-generated information, such as user inputs or commands from other devices.

The DHCT 116 may also include one or more wireless or wired interfaces, also called ports, for receiving and/or transmitting data to other devices. For instance, the DHCT 116 may feature USB (Universal Serial Bus), Ethernet (for connection to a computer), IEEE-1394 (for connection to media devices in an entertainment center), serial, and/or parallel ports. The user inputs may, for example, be provided by a computer or transmitter with buttons or keys located either on the exterior of the terminal or by a hand-held remote control device or keyboard that includes user-actuated buttons.

In one implementation, the DHCT 116 includes system memory 249, which includes flash memory 251 and dynamic random access memory (DRAM) 252, for storing various applications, modules and data for execution and use by the processor 244. Basic functionality of the DHCT 116 is provided by an operating system 253 that is primarily stored in flash memory 251. Among other things, the operating system 253 includes at least one resource manager 267 that provides an interface to resources of the DHCT 116 such as, for example, computing resources.

One or more programmed software applications, herein referred to as applications, are executed by utilizing the computing resources in the DHCT 116. Applications stored in flash memory 251 or DRAM 252 are executed by one or more processors 244 (e.g., a central processing unit or digital signal processor) under the auspices of the operating system 253. Data required as input by an application is stored in DRAM 252 or flash memory 251 and read by processor 244 as need be during the course of the application's execution. Input data may be data stored in DRAM 252 by a secondary application or other source, either internal or external to the DHCT 116, or possibly anticipated by the application and thus created with the application at the time it was generated as a software application, in which case it is stored in flash memory 251. Data generated by an application is stored in DRAM 252 by processor 244 during the course of the application's execution. DRAM 252 also includes application memory 270 that various applications may use for storing and/or retrieving data.

An application referred to as navigator 255 is also resident in flash memory 251 for providing a navigation framework for services provided by the DHCT 116. The navigator 255 registers for and in some cases reserves certain user inputs related to navigational keys such as channel increment/decrement, last channel, favorite channel, etc. The client applications may be resident in flash memory 251 or downloaded into DRAM 252. The navigator 255 also provides users with television related menu options that correspond to DHCT functions such as, for example, providing an interactive program guide, blocking a channel or a group of channels from being displayed in a channel menu, and displaying a video-on-demand purchase list.

The flash memory 251 also contains a platform library 256. The platform library 256 is a collection of utilities useful to applications, such as a timer manager, a compression manager, a configuration manager, an HTML parser, a database manager, a widget toolkit, a string manager, and other utilities (not shown). These utilities are accessed by applications via application programming interfaces (APIs) as necessary so that each application does not have to contain these utilities. Two components of the platform library 256 that are shown in FIG. 2 are a window manager 259 and a service application manager client (SAM) 257.

The window manager 259 provides a mechanism for implementing the sharing of the screen regions and user input. The window manager 259 on the DHCT 116 is responsible for, as directed by one or more applications, implementing the creation, display, and de-allocation of the limited DHCT 116 screen resources. It allows multiple applications to share the screen by assigning ownership of screen regions, or windows. The window manager 259 also maintains, among other things, a user input registry 250 in DRAM 252 so that when a user enters a key or a command via the RC 300 or another input device such as a keyboard or mouse, the user input registry 250 is accessed to determine which of various applications running on the DHCT 116 should receive data corresponding to the input key and in which order. As an application is executed, it registers a request to receive certain user input keys or commands. When the user presses a key corresponding to one of the commands on the RC 300, the command is received by the receiver 246 and relayed to the processor 244. The processor 244 dispatches the event to the operating system 253 where it is forwarded to the window manager 259 which ultimately accesses the user input registry 250 and routes data corresponding to the incoming command to the appropriate application.

The SAM client 257 is a client component of a client-server pair of components, with the server component being located on the headend 111. A SAM database 260 in DRAM 252 includes a data structure of services and a data structure of channels that are created and updated by the headend 111. Many services can be defined using the same application component, with different parameters. Examples of services include, without limitation and in accordance with one implementation, presenting television programs (available through a WatchTV application 262), pay-per-view events (available through a PPV application 264), digital music (not shown), media-on-demand (available through an MOD application 263), and an interactive program guide. In general, the identification of a service includes the identification of an executable application that provides the service along with a set of application-dependent parameters that indicate to the application the service to be provided. As a non-limiting example, a service of presenting a television program could be executed with a set of parameters to view HBO or with a separate set of parameters to view CNN. Each association of the application component (tune video) and one parameter component (HBO or CNN) represents a particular service that has a unique service I.D. The SAM client 257 also interfaces with the resource manager 267, as discussed below, to control resources of the DHCT 116.

Application clients can also be downloaded into DRAM 252 at the request of the SAM client 257, typically in response to a request by the user or in response to a message from the headend. In this non-limiting example DRAM 252 contains an IPG application 272, a media-on-demand application (MOD) 263, an e-mail application 265, and a web browser application 266, among others (not shown). It should be clear to one with ordinary skill in the art that these applications are not limiting and merely serve as examples, among others, for this present embodiment of the invention. Furthermore, one or more DRAM based applications may, as an alternative embodiment, be resident in flash memory 251. These applications, and others provided by the cable system operator, are top level software entities on the network for providing services to the user.

In one implementation, applications executing on the DHCT 116 work with the navigator 255 by abiding by several guidelines. First, an application utilizes the SAM client 257 for the provision, activation, and suspension of services. Second, an application shares DHCT 116 resources with other applications and abides by the resource management policies of the SAM client 257, the operating system 253, and the DHCT 116. Third, an application handles situations where resources are only available with navigator 255 intervention. Fourth, when an application loses service authorization while providing a service, the application suspends the service via the SAM (the navigator 255 will reactivate an individual service application when it later becomes authorized). Finally, an application client is designed to not have access to certain user input keys reserved by the navigator (i.e., power, channel +/−, volume +/−, etc.).

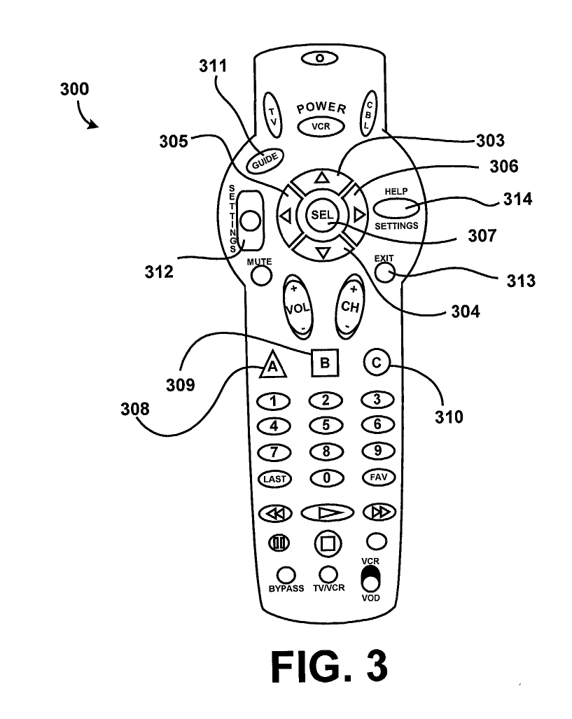

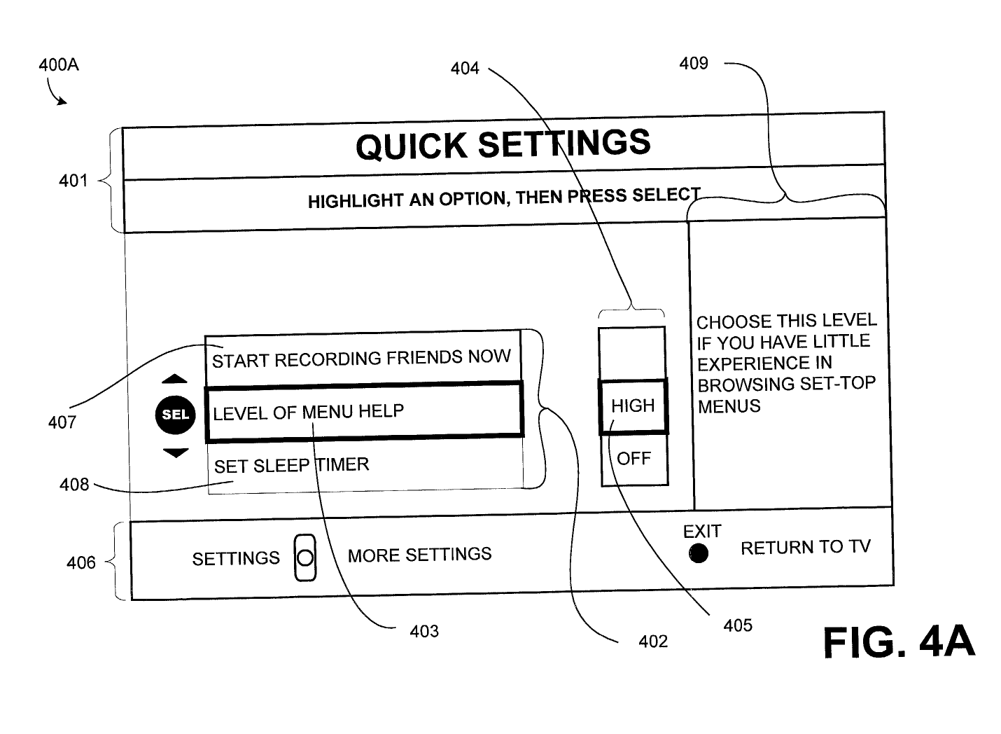

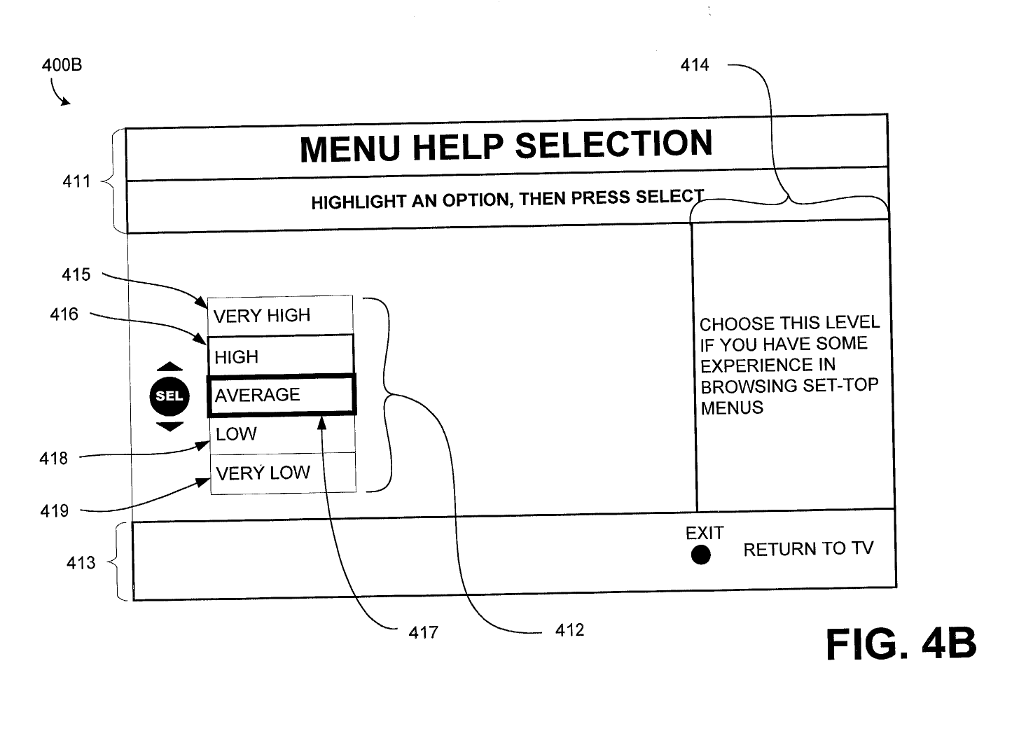

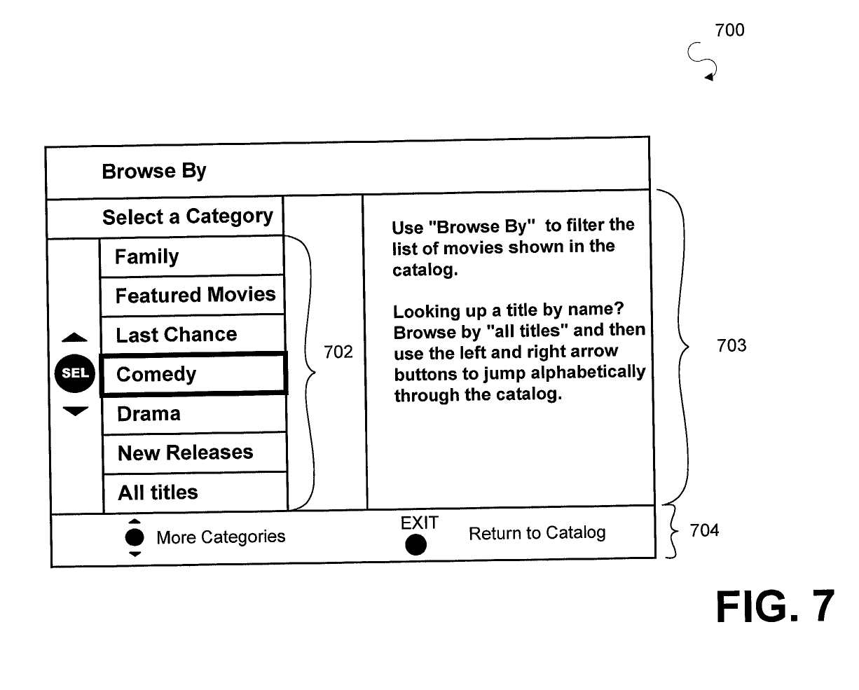

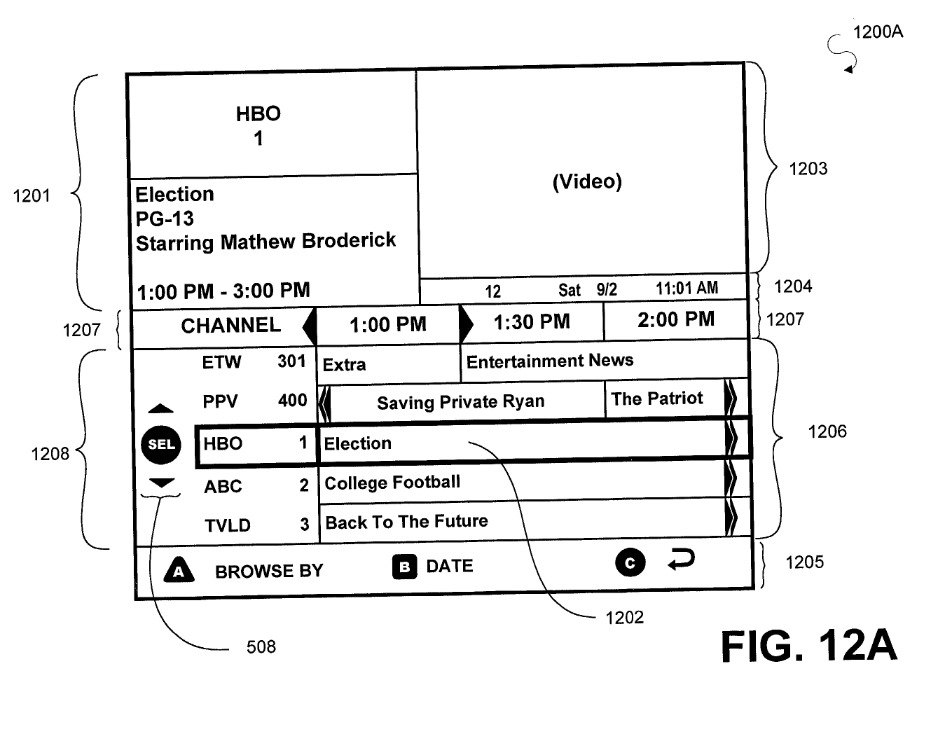

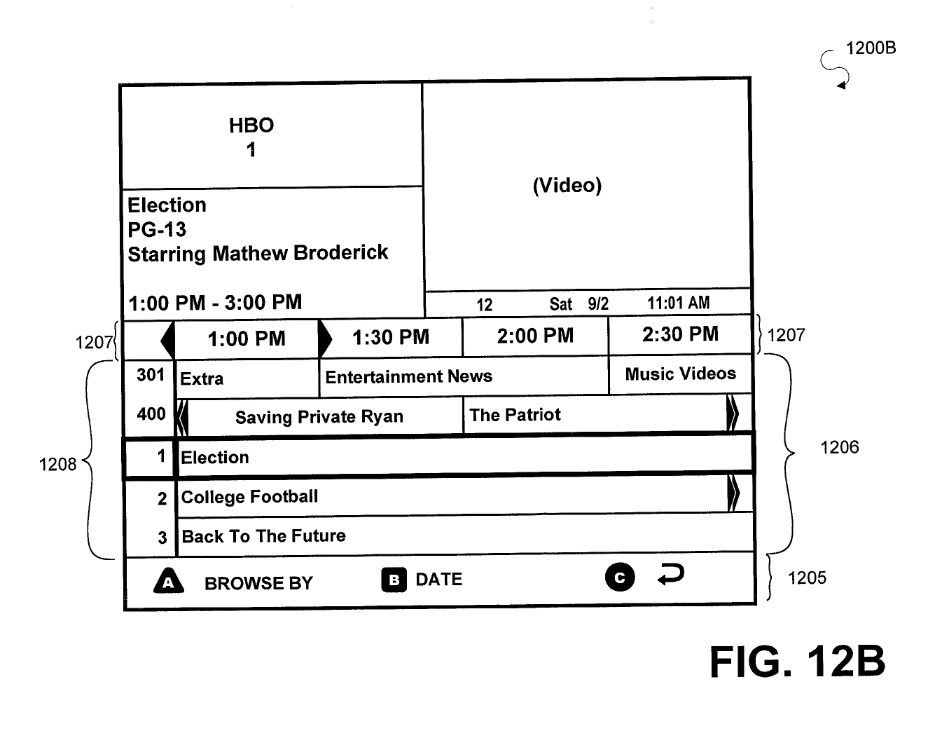

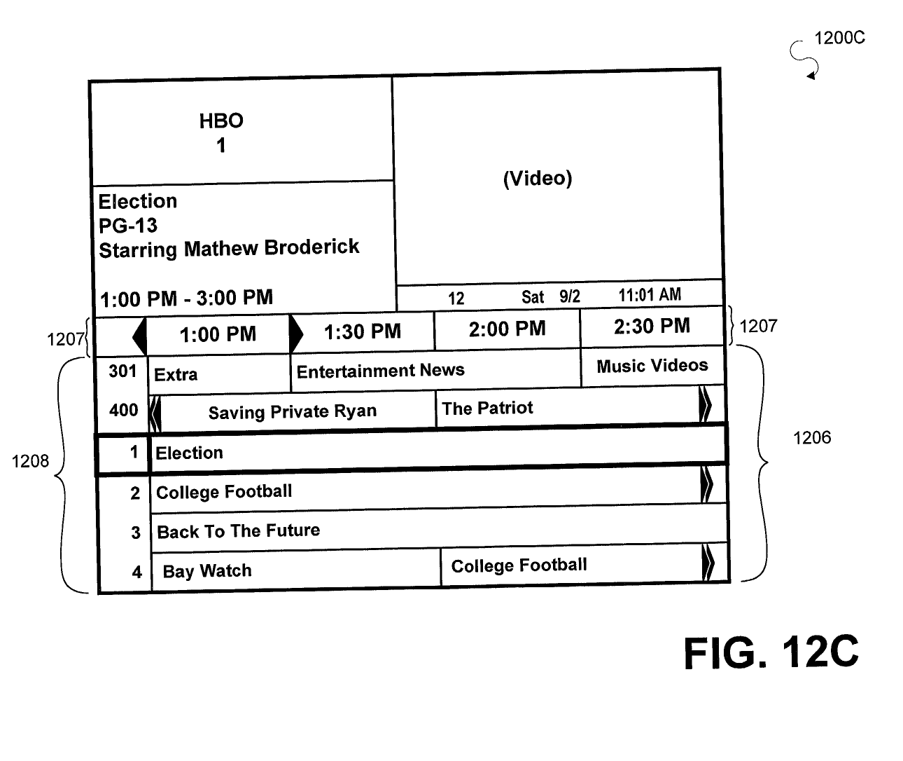

FIG. 3 illustrates a non limiting example of a remote control device (“RC”) 300 that may be used to provide user input to the DHCT 116. The RC 300 includes many buttons for providing user input to the DHCT 116: arrow buttons 303-306 may be used to scroll through and/or to highlight options; a select button 307 may be used to select a currently highlighted option that is provided to a user; a guide button 311 may be used to request an interactive program guide such as, for example, a program guide as shown in FIGS. 12A, 12B, or 12C; a settings button 312 may be used to request a settings window such as, for example, a settings window as shown in FIG. 4A; and a “B” button 309 may be used to request a Browse-By menu such as, for example, a Browse-By menu as shown in FIGS. 7. Other features of RC 300 will be discussed further below. Many alternative methods of providing user input may be used including a remote control device with different buttons and/or button layouts, a keyboard device, a voice activated device, etc. The invention described herein is not limited by the type of device used to provide user input.

With additional reference to FIGS. 2 and 3 throughout the remaining figures, FIG. 4A depicts an example quick settings window 400A that may be provided in response to the activation of the settings button 312 to a user who is not currently receiving a VOD service. As with other window examples discussed below, processor 244 executes program instructions of a designated DHCT application that cause it to direct the window manager 259 to create window 400A via display data that is formatted for television 241. Processor 244 stores the display data or parts thereof in DRAM 252 (as necessary) and transfers the display data to a display output system such as RF output system 248 wherein display data is converted to respective television signals and transmitted to television 241. Of course, the scope of the invention also includes any other method of causing the described windows to appear to the user.

Window 400A includes a heading area 401, an options list 402, a status column 404, a navigation instruction section 406, and an information area 409. In this non-limiting example, the heading area 401 includes the title “QUICK SETTINGS” and the instruction “HIGHLIGHT AN OPTION, THEN PRESS SELECT”. Options list 402 contains three options: the first option 407 corresponds to an option to record the currently tuned channel, the second option 403, which is also the currently highlighted option, corresponds to an option to change the level of help provided in connection with subsequent menus, and the third option 408 corresponds to an option to set a sleep timer. A status column 404 provides indications as to the status of the corresponding options listed in the options list 402. Information area 409 provides the user with information related to the current highlighted status. In this example, the highlighted status area 405 indicates that the current selection for the level of menu help is “high”, and information area 409 states “CHOOSE THIS LEVEL IF YOU HAVE LITTLE EXPERIENCE IN BROWSING SET-TOP MENUS.”

In a preferred embodiment, pressing the select key 307 changes the state of a highlighted status 405. Many other selection methods may also be used including, for example, pressing the left and right arrow keys 305 and 306. In an alternate embodiment, a status column 404 is not provided, and the state of the respective options is inherent in the descriptions contained in the options list 402; the user may press the left and right arrow buttons 305 and 306 to cycle in a consistent periodic fashion through the available selectable states and may then press the select button 307 to activate a desired state. In yet another embodiment, the user may determine in advance via a configuration screen (not shown) which of the above selection methods will be in effect. A first method selected by a user may remain active until a subsequent selection method is requested by a user.

Other possible levels of menu help may include “medium” and “low.” As the user changes the highlighted status via RC 300, information area 409 would change accordingly. For example, if the current status selection for a level of menu help becomes “medium” then information area 409 may state that a user should select a medium level of help if the user has some experience in browsing set-top menus. On the other hand, if the current status selection for a level of menu help becomes “low” then information area 409 may state that a user should select a low level of help if the user has a lot of experience in browsing set-top menus. After a user activates a level of help via the RC 300, then the level of help (i.e. instructions and/or suggestions) provided to a user in connection with a subsequent menu would correspond to the user activated level of help.

Although in one embodiment, a default level of menu help may be “high”, in other embodiments, a default level of menu help may be “medium” or “low”. Furthermore, although in this embodiment the selectable levels of menu help are high, medium, and low, in other embodiments the levels of help may be represented by other designations, such as, for example, alphanumeric characters, and may include any number of selectable levels of help. In yet another embodiment, the level of menu help may be adjusted via a general settings window (not shown). A general settings window may be similar to a quick settings window, but may include a greater number of menu options.

FIG. 4B depicts an example quick settings window 400B that may be provided in response to the activation of the help settings button 314 on the RC 300. Window 400B includes a heading area 411, an options list 412, a navigation instruction section 413, and an information area 414. In this non-limiting example, the heading area 411 includes the title “MENU HELP SELECTION” and the instruction “HIGHLIGHT AN OPTION, THEN PRESS SELECT”. Options list 412 contains five options: very high 415, high 416, average 417, low 418, and very low 419. Information area 414 provides the user with information related to a currently highlighted option. In this example, the currently highlighted status is “average” 417, and information area 414 states “CHOOSE THIS LEVEL IF YOU HAVE SOME EXPERIENCE IN BROWSING SET-TOP MENUS.” After a user selects a level of help via the RC 300, then the level of help provided to a user in relation to a subsequent menu would correspond to the user selected level of help.

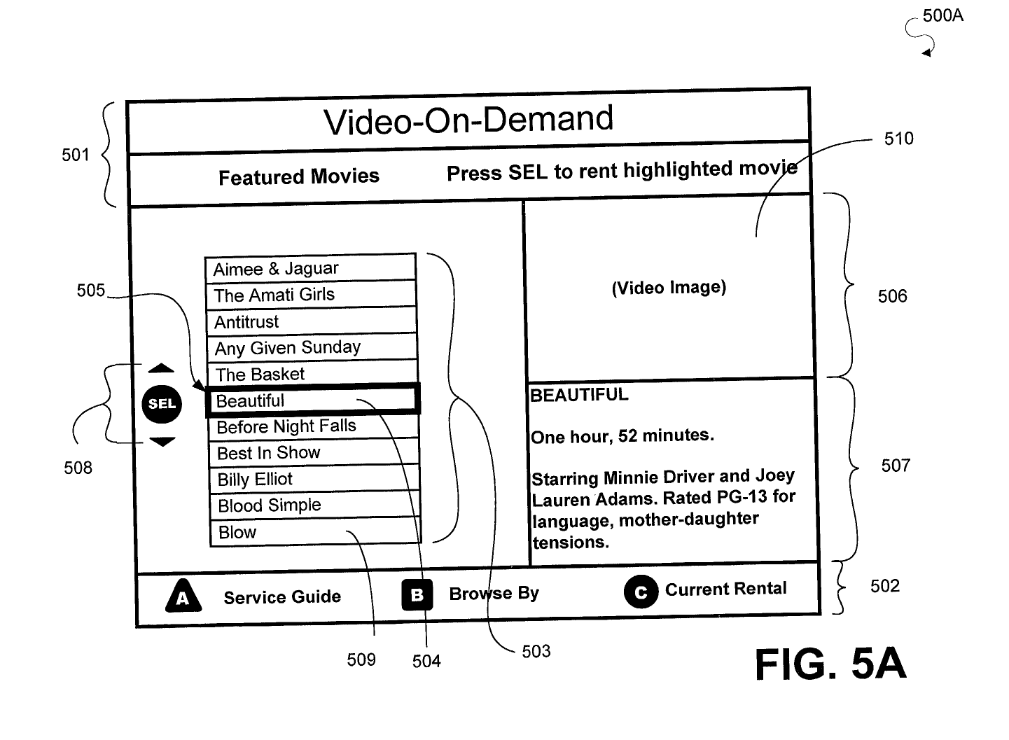

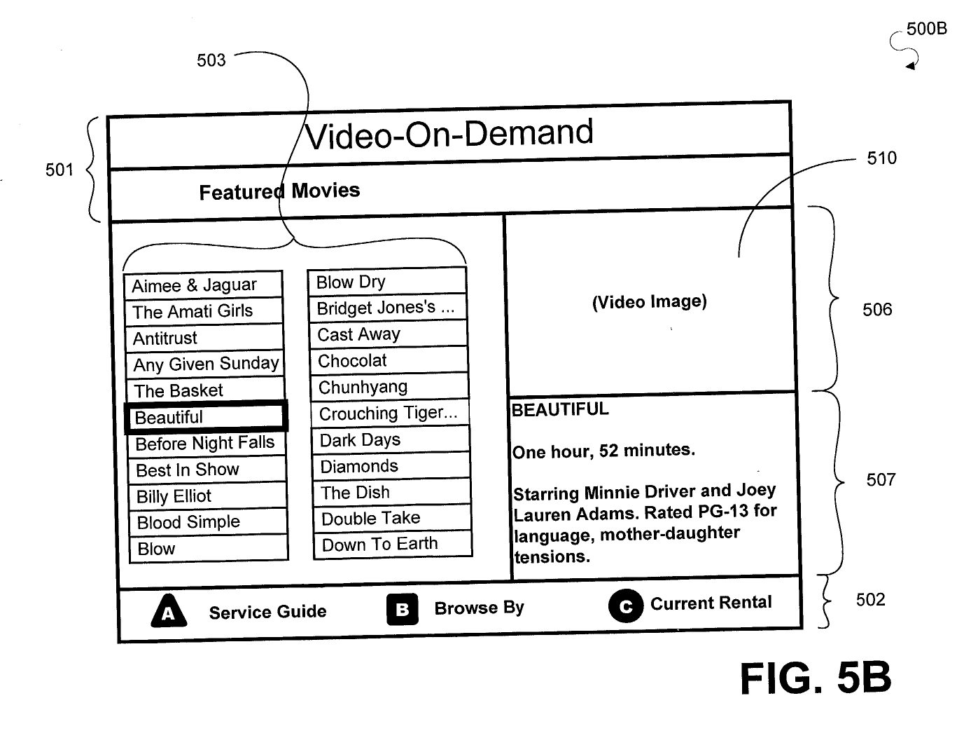

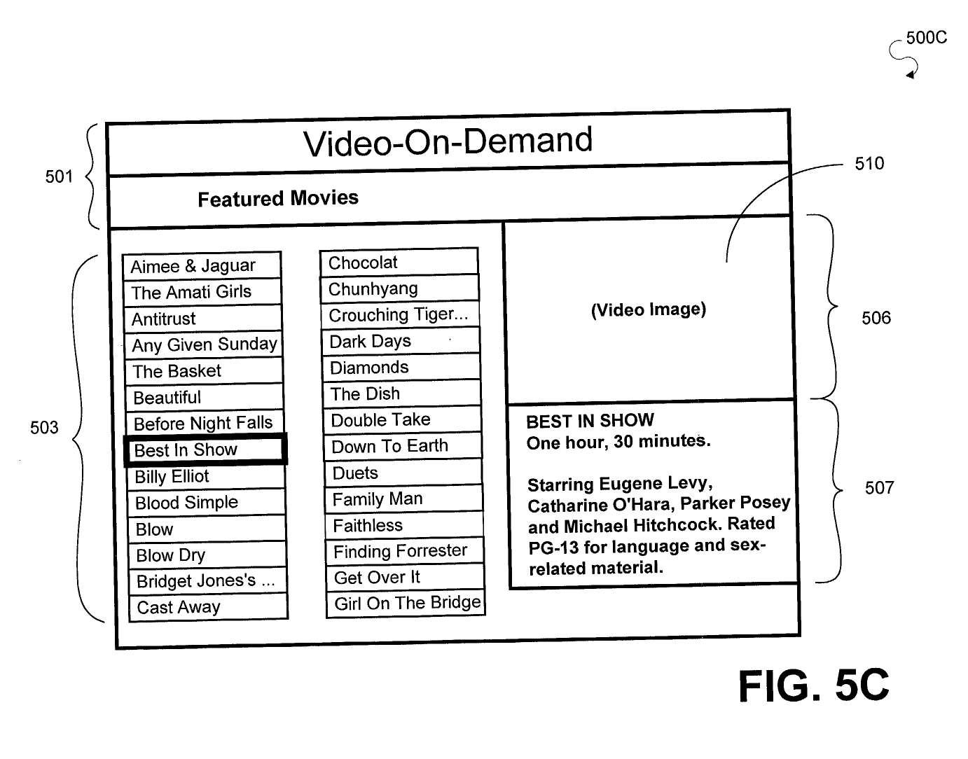

FIG. 5A is a diagram depicting an example VOD catalog window 500A containing a high level of menu help. VOD catalog window 500A is presented to a user who accesses a VOD channel when a high level of menu help is currently active. A user may utilize the catalog window 500 in order to request a video-on-demand rental. Top portion 501 of example window 500 typically contains one or more headings and/or instructions, while the bottom portion 502 typically illustrates relevant navigation buttons available on the RC 300. Video menu 503 contains the titles of video presentations, such as the video title “Beautiful” 504, that are available for rent, as well as a highlighted title area 505. Browsing symbol 508 suggests to the user that the up and down arrow buttons 303 & 304 may be used to scroll through the video rental list, and that the select button 307 may be used to request a currently highlighted video title. For example, a user may activate the down arrow on the RC 300 until the selection “Blow” 509 is displayed in the highlighted title area 505 and then request to see the video titled “Blow” 509 by activating the select button 307. In an alternative embodiment, activating the up and down arrow buttons 303, 304 on the RC 300 results in the shifting of the highlighted title area 505 rather that the shifting of the video titles, at least until the top or bottom selection is highlighted. A reduced screen area 506 displays an image 510 corresponding to the video title displayed in the highlighted title area 505. As the user scrolls through the video menu 503, the video image 510 displayed in the reduced screen area 506 changes accordingly. In an alternative embodiment, the reduced screen area may display a video stream corresponding to a media presentation that the user was viewing prior to requesting the VOD catalog window 500A. Information area 507 contains information about the currently highlighted movie 504. In this example, the information includes the name (Beautiful), duration (one hour and 52 minutes), and rating (PG-13) of the highlighted movie 504.

FIG. 5B is a diagram depicting an example VOD catalog window 500B containing a medium level of menu help. VOD catalog window 500B is presented to a user who accesses a VOD channel when a medium level of menu help is currently active, and differs from window 500A (FIG. 5A) in that the former contains fewer instructions and suggestions. For example, window 500B does not contain browsing symbol 508, nor the instruction “Press SEL to rent highlighted movie” in the top portion 501. However, window 500B does contain a more extensive video menu 503 containing a greater number of movie title selections. Therefore it can be seen that providing a user with a lower level of menu help can allow the presentation of alternative data to the user.

In an another embodiment, a VOD catalog window containing a medium level of help (not shown), may include a larger “reduced screen area” instead of additional movie title selections. The larger “reduced screen area” may for example occupy areas 506, 507, and a portion of the area that would otherwise be occupied by video menu 503. In this manner the user can be provided with a larger video image than video image 510.

FIG. 5C is a diagram depicting an example VOD catalog window 500C containing a low level of menu help. VOD catalog window 500B is presented to a user who accesses a VOD channel when a low level of help is currently active, and differs from window 500B (FIG. 5B) in that the former contains fewer instructions and suggestions. For example, window 500C does not contain the bottom portion 502 that is included in window 500B. Instead, window 500C contains an even greater number of movie title selections. In an alternative embodiment, a significantly smaller VOD catalog window (not shown) displaying only a few selections may be overlaid on top of a video presentation that the user is watching and may be located at or near a corner of the television screen. In this manner, the user may browse movie titles via the smaller window while being able to immediately turn his or her attention to the video presentation as desired.

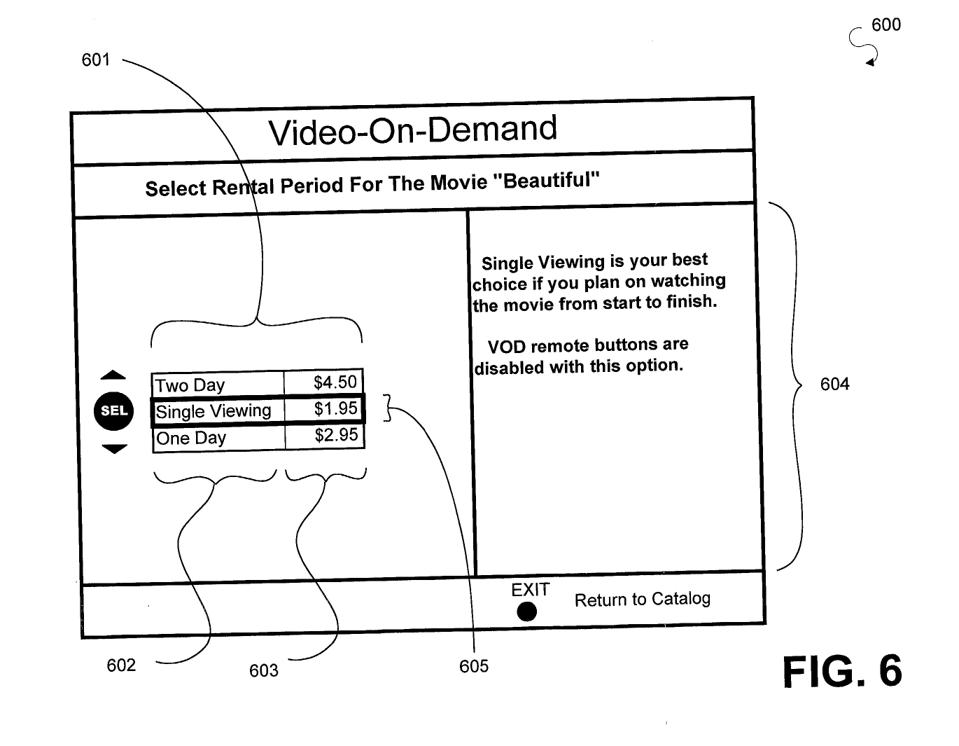

FIG. 6 is a diagram depicting an example rental period selection window 600 containing a high level of menu help. Selection window 600 is presented to a user who selects a movie from a VOD catalog window when a high level of menu help is currently active. Rental period menu 601 contains rental periods 602, rental prices 603, and a highlighted rental option 605. Rental period information section 604 provides information about the rental period displayed in the highlighted selection area. A user may select a highlighted rental option 605 by activating the select button 307 (which would begin the process of setting up a video-on-demand session for the requested movie). Alternatively, the user may cancel the rental request by activating the exit button 313. A rental period selection window containing a lower level of menu help may exclude one or more elements shown in rental period selection window 600. As a non-limiting example, information section 604 may be omitted from a rental period selection window containing a lower level of menu help.

FIG. 7 is a display diagram of a browse-by window 700 containing a high level of menu help. Browse-by window 700 is presented to a user in response to the activation of the “B” button 309 while being presented with the VOD catalog window 500A. The browse-by window 700 can be used to select a category from a category menu 702. Category menu 702 includes a plurality of browse-by categories for browsing available media titles. In a description portion 703 of the browse-by window 700, a brief description is displayed about a highlighted category in the category menu 702. The various categories are essentially used as filters for the movies shown in a VOD catalog window. Browse-by categories may include, for example, featured movies, action/adventure, adult, comedy, drama, family, new releases, last chance, specials, and “all titles”, among others. Once the user selects a category from the browse-by window 700, the browse-by window 700 disappears and the user is presented with a VOD catalog window containing a set of MOD titles corresponding to the selected category. The user may alternatively terminate the browse-by window 700 without changing the title display by following instructions shown in a bottom portion 704 of the browse-by window 700. In this example, the user may terminate the browse-by window 700 by activating the Exit button 313 on the RC 300. A browse-by window containing a lower level of menu help may exclude one or more elements shown in browse-by window 700. As a non-limiting example, description portion 703 may be omitted from a browse-by window containing a lower level of menu help.

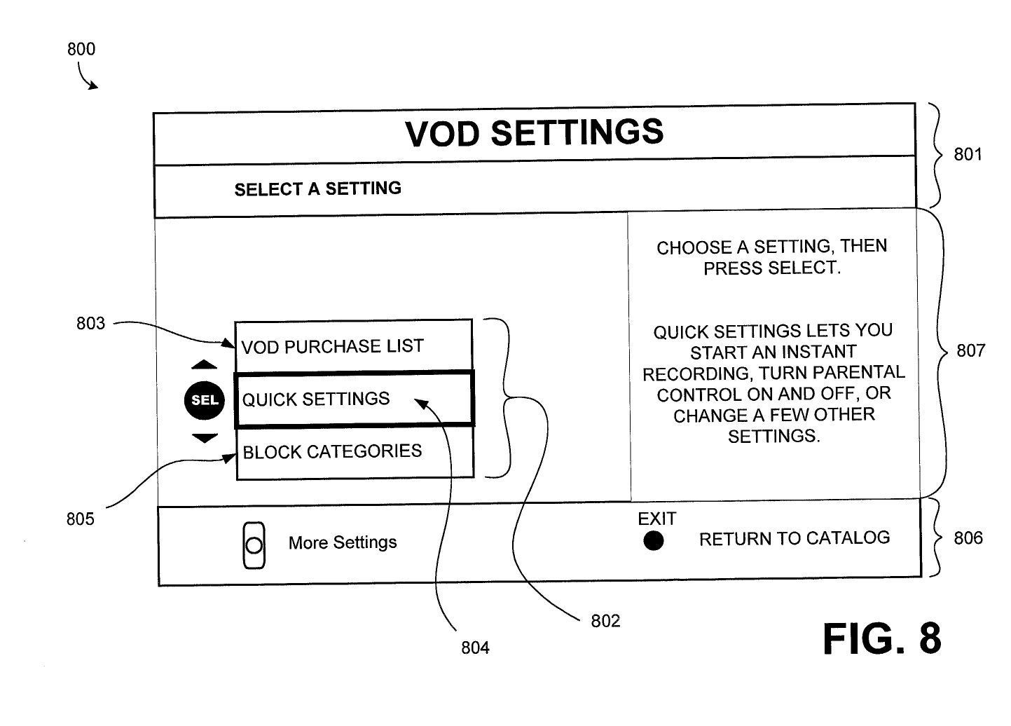

FIG. 8 is a diagram depicting an example VOD settings window 800 containing a high level of menu help. Window 800 may be provided in response to the activation of the settings button 312 to a user currently receiving a VOD service or viewing a VOD window. Top portion 801 contains the heading “VOD SETTINGS” and the instruction “SELECT A SETTING.” Options menu 802 contains three selections: a “VOD purchase list” option 803, a “quick settings menu” option 804, and a “block categories” option 805. The quick settings menu option 804 (the currently highlighted option) can be used to access a quick settings window similar to the one shown in FIG. 4A. Information section 807 contains information about the currently highlighted option as well as instructions on using the VOD settings menu. Bottom portion 806 informs the user that the user can return to a VOD catalog window by activating the “EXIT” button 313 on the RC 300. A VOD settings window containing a lower level of menu help may exclude one or more elements shown in VOD settings window 800. As a non-limiting example, information section 807 may be omitted from VOD settings window containing a lower level of menu help.

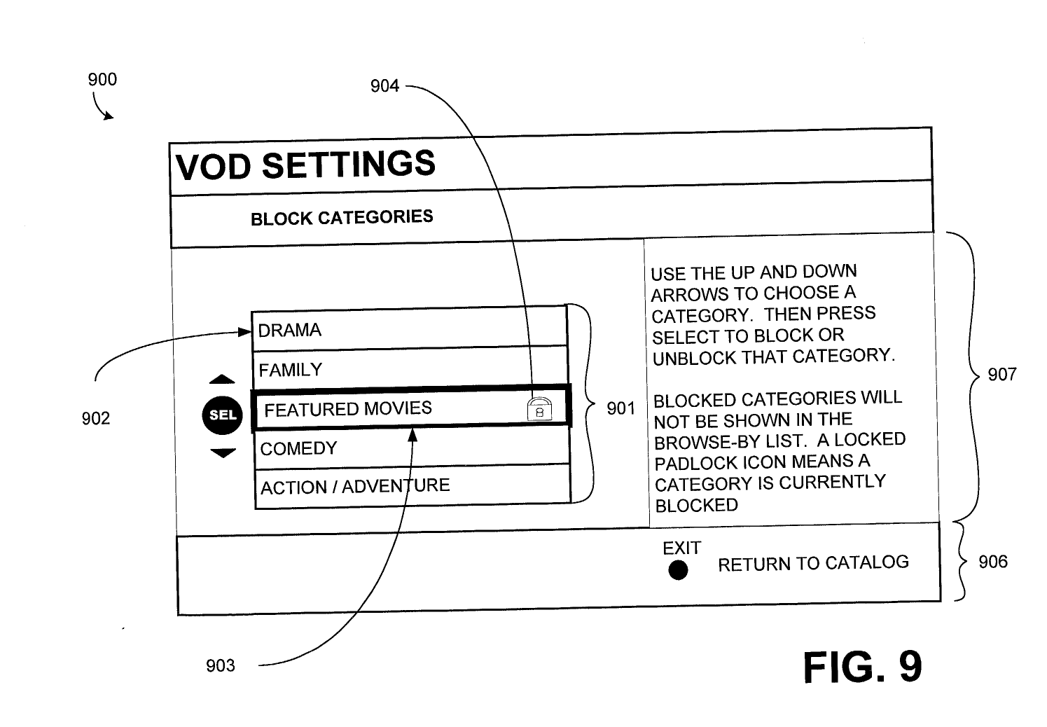

FIG. 9 is a diagram depicting an example VOD block categories window 900 containing a high level of menu help. The VOD block categories window 900 is provided to a user after the user selects the block categories option 805 while being presented with window 800 (FIG. 8). A block categories list 901 includes a highlighted block category selection 903 as well as other block category selections, such as, for example, block category selection 902. Once a user activates a block category, media titles falling under the activated category will not be shown in a VOD catalog that is subsequently presented to the user. A locked padlock symbol 904 is used to indicate that a category is currently activated. An information section 907 provides the user with instructions and/or information related to the VOD block categories window 900. Information section 907 may, for example, provide information as to the meaning of an item contained in window 900. A VOD block categories window containing a lower level of menu help may exclude one or more elements shown in VOD block categories window 900. As a non-limiting example, information section 907 may be omitted from a VOD block categories window containing a lower level of menu help.

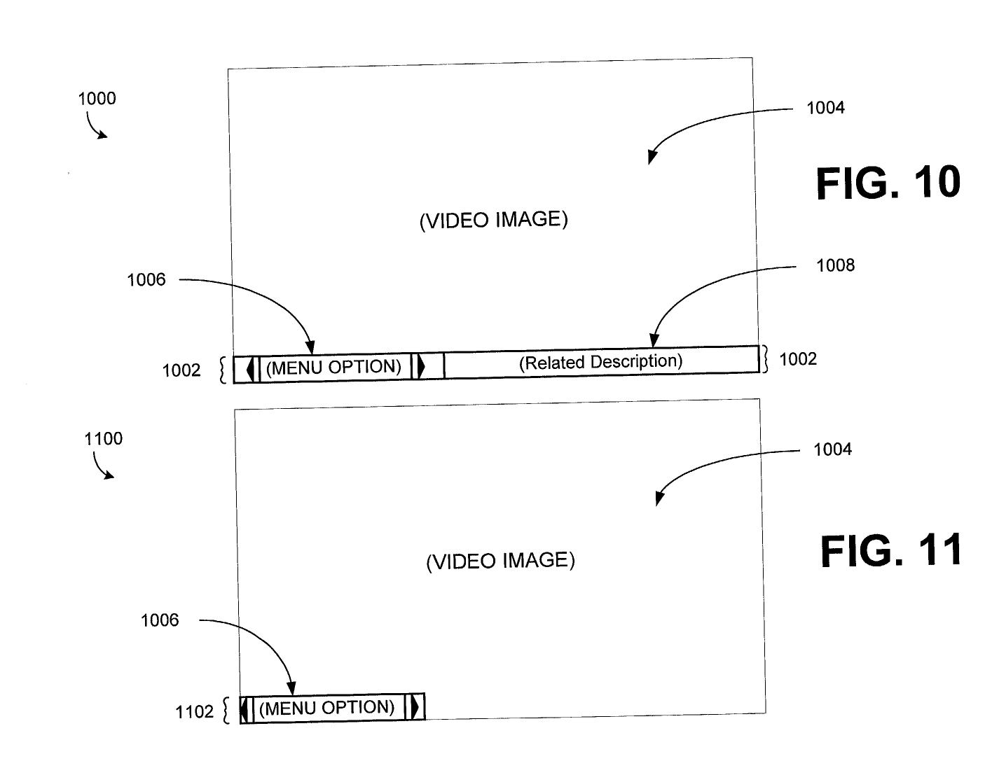

FIGS. 10 and 11 depict example screen layouts 1000 and 1100 that include menus 1002 and 1102, respectively, and video images 1004. The video images 1004 may correspond to a video presentation that a user was watching prior to requesting a menu. Menu 1002 is presented to a user when a medium level of menu help is active whereas menu 1102 is presented when a low level of menu help is active. Menus 1002 and 1102 may, for example, provide the functionality of one of the windows described in FIGS. 6-9, namely, that of a rental period selection window 600, a browse-by window 700, or a VOD settings window 800. Each of the menus 1002 and 1102 includes a scrollable menu option field 1006. A user may press the left and right arrow buttons 305 and 306 to cycle in a consistent periodic manner through the available selectable options and may then press the select button 307 to select a desired option. Menu 1002 differs from menu 1102 in that the former includes a related description field 1008, and therefore provides a user with more help in making a selection. As a non-limiting example, if menu 1002 provides the functionality of rental period selection window 600, and if the displayed option is “Single viewing”, then the brief description may state “VOD remote buttons are disabled with this option.” The content of the related description field 1008 may scroll from right to left in order to display a description that may not otherwise fit in the field 1008.

FIG. 12A depicts an example interactive program guide (IPG) window 1200A that contains a high level of menu help. The top left portion of the example window 1200A is a detailed focus area 1201 that includes detailed channel information for an “in-focus” media corresponding to highlighted title area 1202 in a title menu 1206. In this example, the detailed channel information includes channel number (1), channel name (HBO), media title (Election), duration (1:00 PM-3:00 PM), and rating (PG-13). The media presentation showing on the channel to which the DHCT 116 is currently tuned (for which audio is also playing, and which is typically the media occupying the full screen before the IMG client application 272 is activated) is displayed in a reduced screen area 1203. In this example, the media presentation being shown in reduced screen area 1203 corresponds to channel 10. Immediately below the reduced screen area 1203 is an information banner 1204 showing the channel to which the DHCT 116 is currently tuned, the current day and date, and the current time. The middle left portion of example window 1200A includes a channel area 1208 that is related to the selected ordering format and is described in more detail below. Heading portion 1207 contains headings related to the information displayed in the channel area 1208 and a title menu 1206. The title menu 1206 contains media titles corresponding to media presentations that are or will be available for viewing during the time periods listed under the heading portion 1207. A highlighted title area 1202 is vertically centered in the title menu 1206. The user can scroll up and down to the various media titles listed in the title menu 1206 by using the up and down arrow button 303 and 304 on the RC 300.

The title menu 1206 includes media names organized in a grid of rows of channels and columns of time. The channel area 1208 includes a vertical list of channels organized sequentially by channel number. The title menu 1206 can be scrolled in both time and channel dimensions. In this non-limiting example, channel “1” corresponds to the HBO channel and is the lowest channel number displayed in the channel area 1208. Continuing with this non-limiting example, the left-most time column in the title menu 1206 is set to include titles of media presentations scheduled to be broadcast about two hours into the future, and where the highlighted media title corresponds to a media presentation on the lowest available channel. Therefore, in this example, the movie “Election” which is on channel 1 and which is scheduled to be broadcast during the time interval between 1:00 p.m. and 1:30 p.m. is the currently highlighted media title. It should be noted that the media presentation being shown in reduced screen area 1203 and referenced in information banner 1204 does not necessarily correspond to the highlighted media title, as explained above.

The bottom area 1205 of example window 1200A indicates functionality for the “A” 308, “B” 309, and “C” 340 buttons on the RC 300: the “A” button 308 is for requesting a “Browse-by” menu; the “B” button 309 is for selecting a different date for the media titles shown in title menu 106; and the “C” button 310 is for viewing media titles which correspond to media presentations that are or will be playing during a current or up-coming time period, and which include at least one title corresponding to the currently tuned television channel.

With additional reference to FIG. 12A, FIGS. 12B & 12C depict example IPG windows 1200B and 1200C respectively. IPG window 1200B contains a medium level of menu help whereas IPG window 1200C contains a low level of menu help. IPG windows 1200B and 1200C differ from IPG window 1200A in that they have a larger title menu 1206 that covers a broader time period, and a smaller channel area that does not include a browsing symbol 508 or channel names. Furthermore, IPG window 1200C differs from IPG window 1200B in that the former does not have a bottom portion 1205, but instead has a larger title menu 1206 and a larger channel area 1208. Therefore, it can be seen that as the level of help provided via an IPG interface decreases, the amount of television program information provided via the interface may increase.

In one embodiment of the invention, if a user does not provide input within a predetermined amount of time while a menu or an IPG is being presented to the user, then additional help is provided to the user. The additional help may be, for example, in the form of a banner or window that contains suggestions or instructions. As a non-limiting example, a help window may be displayed at or near a corner of the television screen, and a help banner (stationary or scrolling) may be displayed at or near the bottom or top portion of a television screen. The suggestions or instruction contained in a help window or banner may be in the form of textual, graphical, or video data. Windows and banners that provide help to users may have a variety of shapes including, for example, square, rectangular, circular, elliptical, oval, triangular, polygonal, etc. Additional help may also be provided in the form of audio suggestions or instructions.

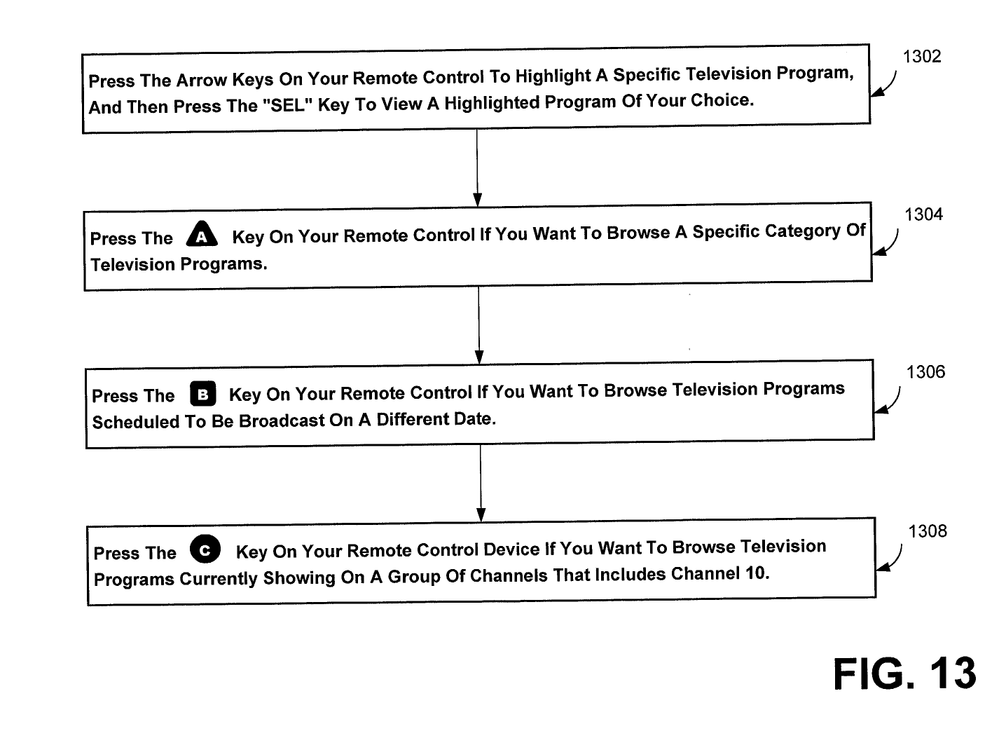

FIG. 13 depicts one possible sequence of help banners 1302, 1304, 1306, & 1308 that may be presented to a user who does not provide input within a predetermined amount of time after the initial presentation of an IPG. Each banner may be displayed for a few seconds and may then be replaced with a subsequent banner. In this non-limiting example, the banners provide instructions on using the RC 300 in connection with IPG window 1200A (FIG. 12A): banner 1302 states “Press the arrow keys on your remote control to highlight a specific television program, and then press the “SEL” key to view a highlighted program of your choice”, banner 1304 states “Press the ‘A’ key on your remote control if you want to browse a specific category of television programs”, banner 1306 states “Press the ‘B’ Key on your remote control if you want to browse television programs scheduled to be broadcast on a different date”, and banner 1308 states “press the ‘C’ Key on your remote control device if you want to browse television programs currently showing on a group of channels that includes channel 10.”

Help banners may be presented to a user in a cyclical and periodic manner until a user provides input to the DHCT 116, or may be presented to the user for only a predetermined time period. Furthermore, help banners may either be stationary or scrolling. In an alternative embodiment, help is provided to the user in one or more windows having a variety of shapes and locations. As a non-limiting example, help may be provided to a user via detailed focus area 1201, bottom portion 1205, and/or reduced screen area 1203.

In one embodiment of the invention, a user is provided with a high level of menu help in connection with an initial presentation of a menu. The level of help provided with a subsequent presentation of such menu may be lower. In such an embodiment, a level of help provided in a subsequent presentation of a menu may depend on a parameter that is either directly or indirectly related to an expected level of experience that may be attained by the user in using the menu. As a non-limiting example, during an initial time period of renting a DHCT 116, a user may be provided with a high level of menu help in connection with DHCT menus, then during a subsequent time period the user may be provided with a relatively lower level of menu help. As another non-limiting example, the level of help provided in conjunction with a specific menu may decrease after the menu is accessed or used at a certain household more than a predetermined number of times.

It should be emphasized that the above-described embodiments of the present invention, particularly any “preferred embodiments”, are merely possible examples, among others, of the implementations, setting forth a clear understanding of the principles of the inventions. Many variations and modifications may be made to the above-described embodiments of the invention without departing substantially from the principles of the invention. All such modifications and variations are intended to be included herein within the scope of the disclosure and present invention and protected by the following claims.

What is claimed is:

1. In a media services system having a user interface including a display device and an input device, a method of providing a menu and menu related information, the method comprising:
providing a user with at least one selection for determining a level of menu help;
receiving a first input identifying a selection for determining a level of menu help;
receiving a second input requesting a menu;
providing a user with the requested menu; and
providing the user with menu related information that is responsive to the selection identified via said first input.

2. The method of claim 1, where the method is implemented via a client device located at a customer premises.

3. The method of claim 1, where the method is implemented via a server device capable of communicating with a client device located at a customer premises.

4. The method of claim 1, where the menu and the menu related information are displayed contemporaneously via the display device.

5. The method of claim 4, where the display device is a television.

6. The method of claim 1, where a level of menu help is from a group consisting of high, medium, and low.

7. The method of claim 1, where a level of menu help is identified in relation to a user's experience level.

8. The method of claim 1, where the first input and the second input are received via a remote control device.

9. The method of claim 1, where the menu is a television menu.

10. The method of claim 9, where the television menu is an interactive program guide.

11. The method of claim 9, where the television menu is a television settings menu.

12. The method of claim 1, where the menu is a video-on-demand (VOD) menu.

13. The method of claim 12, where the VOD menu is a VOD catalog.

14. The method of claim 12, where the VOD menu is a VOD settings menu.

15. The method of claim 1, where the menu related information includes an instruction on using the menu.

16. The method of claim 1, where the menu related information includes an instruction on using an input device.

17. The method of claim 1, where the menu related information includes information about a menu selection.

18. The method of claim 1, where the menu related information includes a suggestion about making a menu selection.

19. In a media services system having a user interface including a display device and an input device, a method of providing a menu and menu related information, the method comprising:
providing a user with at least one selection for determining a level of menu help;
receiving a first input identifying a selection for determining a level of menu help;
receiving a second input requesting a menu;
providing a user with the requested menu;
providing the user with a first level of menu help if the first input identifies a first selection; and
providing the user with a second level of menu help if the first input identifies a second selection.

20. The method of claim 19, where the method is implemented via a client device located at a customer premises.

21. The method of claim 19, where the method is implemented via a server device capable of communicating with a client device located at a customer premises.

22. The method of claim 19, where the menu and the menu related information are displayed contemporaneously via the display device.

23. The method of claim 19, where the display device is a television.

24. The method of claim 19, where a level of menu help is from a group consisting of high, medium, and low.

25. The method of claim 19, where a level of menu help is identified in relation to a user's experience level.

26. The method of claim 19, where the first input and the second input are received via a remote control device.

27. The method of claim 19, where the menu is a television menu.

28. The method of claim 19, where the menu is a video-on-demand (VOD) menu.

29. A system for providing a media services menu and menu related information, comprising:
a storage device; and
logic stored in said storage device and that is configured to cause a processor to:
provide a user with a menu requested by the user,
provide the user with a first level of menu help if the first input identifies a first selection, and
provide the user with a second level of menu help if the first input identifies a second selection.

30. The system of claim 29, where the storage device is contained in a client device located at a customer premises.

31. The system of claim 29, where the storage device is contained in a server device.

32. The system of claim 29, where a level of menu help is from a group consisting of high, medium, and low.

33. The system of claim 29, where a level of menu help is identified in relation to a user's experience level.

34. The system of claim 29, where the input device is a remote control device.

35. The system of claim 29, where the menu is a television menu.

36. The system of claim 29, where the menu is a video-on-demand (VOD) menu.

37. In a media services system having a user interface including a display device and an input device, a method of providing a menu and menu related information, the method comprising:
receiving user input requesting a menu;
providing a user with the requested menu; and
providing the user with menu related information if the user does not select an option identified by said menu within a predetermined time period after the user is presented with the requested menu.

38. The method of claim 37, where the menu is a television menu.

39. The method of claim 37, where the menu is a video-on-demand (VOD) menu.

40. The method of claim 37, where the menu related information includes an instruction on using the menu.

41. The method of claim 37, where the menu related information includes an instruction on using an input device.

42. The method of claim 37, where the menu related information includes information about a menu selection.

43. The method of claim 37, where the menu related information includes a suggestion about making a menu selection.

44. A system for providing a media services menu and menu related information, comprising:
a storage device; and
logic stored in said storage device and that is configured to cause a processor to:
provide a user with a menu requested via user input; and
provide the user with menu related information if the user does not select an option identified by said menu within a predetermined time period.

45. The system of claim 44, where the menu and the menu related information are displayed contemporaneously via a television.

46. The system of claim 44, where the storage device is contained in a client device located at a customer premises.

47. The system of claim 44, where the storage device is contained in a server device.

48. The system of claim 44, where the menu is a television menu.

49. The system of claim 44, where the menu is a video-on-demand (VOD) menu.

50. The system of claim 44, where the menu related information includes an instruction on using the menu.

51. The system of claim 44, where the menu related information includes an instruction on using an input device.

52. The system of claim 44, where the menu related information includes information about a menu selection.

53. The system of claim 44, where the menu related information includes a suggestion about making a menu selection.

54. In a media services system having a user interface including a display device and an input device, a method of providing a menu and menu related information, the method comprising:
receiving user input requesting a menu;
providing a user with the requested menu; and
providing the user with menu related information that is responsive to a parameter that is related to a level of experience that the user has in using said menu.

55. The method of claim 54, where the method is implemented via a client device located at a customer premises.

56. The method of claim 54, where the method is implemented via a server device capable of communicating with a client device located at a customer premises.

57. The method of claim 54, where the parameter is based on a number of times that the menu is provided via a client device located at a user's premises.

58. The method of claim 54, where the parameter is based on a length of a user subscription period for media services.

59. A system for providing a media services menu and menu related information, comprising:
a storage device; and
logic stored in said storage device and that is configured to cause a processor to:
provide a user with a menu requested via user input, and
provide the user with menu related information that is responsive to a parameter that is related to a level of experience that the user has in using said menu.

60. The system of claim 59, where the parameter is based on a number of times that the menu is provided via a client device located at a user's premises.

61. The system of claim 59, where the parameter is based on a length of a user subscription period for media services.
